(19) United States
(12) Patent Application Publication
(10) Pub. No.: US 2001/0053953 A1
(43) Pub. Date: Dec. 20, 2001

(54) Antilock braking control method and system

(76) Inventors: Shao-Wei Gong, Cookeville, TN (US); Kwun-Lon Ting, Cookeville, TN (US)

Correspondence Address: Kwun-Lon Ting, 1400 Sherwood Lane, Cookeville, TN, 38501, US

(21) Appl. No.: 09/829,029

(22) Filed: Apr. 9, 2001

Related U.S. Application Data
(60) Provisional application No. 60/212,524, filed on Jun. 16, 2000.
(60) Provisional application No. 60/212,525, filed on Jun. 16, 2000.
(60) Provisional application No. 60/212,526, filed on Jun. 16, 2000.

(51) Int. Cl. B60T 8/66

(52) U.S. Cl. 701/70; 303/166; 701/71

(57) ABSTRACT

This application discloses various methods of braking control and ABS systems based on acceleration comparison methods. The methods and ABS systems can have various embodiments. The preferred embodiments are acceleration sequence comparison method, acceleration difference comparison method, and acceleration sequence and difference comparison method. Various ABS systems can be constructed on the basis of the methods disclosed in this application.

This invention relates to an anti-lock braking system (ABS) fitted to a wheeled vehicle, which functions to allow the driver to reduce the speed of a wheeled vehicle or to bring the vehicle to a halt and to allow the driver to have a steering capability by preventing the wheel of vehicle lock-up during braking. This application claims the priority of provisional applications, No. 60/212,524, filing date Jun. 16, 2000; No. 60/212,525, filing date Jun. 16, 2000; No. 60/212,526, filing date Jun. 16, 2000.

### FIELD OF THE INVENTION

### BACKGROUND OF THE INVENTION

An anti-lock braking system is a closed-loop control device, which mainly consists of wheel-speed sensors, hydraulic modulator, actuators in the hydraulic modulator, and the electronic control unit (ECU) for signal processing and control. It is documented that, at the maximum point on the adhesion/slip curve, the moving object in the braking process reaches the limit between the stable and unstable ranges. From this point on, any further increase of the braking torque does not increase braking force. The result from an increasing braking torque is that the vehicle tends towards skidding in the unstable range (“Automotive Handbook,” Robert Bosch GmbH, 1996.)

Based on the knowledge and information from the adhesion/slip curve, the closed-loop control process of ABS can be described as: first, the wheel-speed sensor monitors the motion of the wheel of the vehicle. If the wheel shows signs of slip, and if these slips exceed the defined critical values, the ABS controller sends commands to the solenoid-valve unit to stop or reduce the buildup of wheel-brake pressure until the risk of lock-up has passed. The brake pressure is then built up again to ensure that the wheel is effectively braked. During the course of the automatic brake control, it is necessary to detect the wheel motion, and to keep the wheel slip in the slip range with the maximum braking force by a succession of pressure-buildup, pressure-reduction, and pressure-holding processes. To achieve such a closed-loop control process, a number of inventions have presented a variety of control methods:

U.S. Pat. No. 3,612,622;

U.S. Pat. No. 3,718,374;

U.S. Pat. No. 3,953,081;

U.S. Pat. No. 4,665,490;

U.S. Pat. No. 4,739,484;

U.S. Pat. No. 4,917,444;

U.S. Pat. No. 5,487,598;

U.S. Pat. No. 5,644,490;

U.S. Pat. No. 5,938,713;

U.S. Pat. No. 3,612,622 to Riordan presents a skid control system for a wheeled vehicle, which varies the braking pressure as a function of the slip and the difference between the vehicle speed and the wheel speed. In the system disclosed therein, the wheel speed signal is obtained, and, also, an analogue circuit is used to get the instantaneous vehicle velocity. The instantaneous vehicle velocity is fed to a difference circuit, producing an output signal to cause the actuation of a modulator to control the brake pressure.

U.S. Pat. No. 3,718,374 to Ochia presents a skid control system for automotive vehicles. In this system, a wheel speed detector and a memory circuit connected to the detector are used to store the initial speed of the vehicle at the start of braking. A function generator also converts the detected fluid pressure into an arbitrary integrated function. The integrated function is compared to the stored initial speed of the vehicle to derive a difference value which is amplified and supplied to a comparator connected to the wheel speed detector to provide a control signal to operate a servo mechanism to control the braking system.

U.S. Pat. No. 3,953,081 to King presents an ABS design, which detects and compares the difference between the force generated from the frictional loading between the brake shoe and the drum and the force generated between the tire and the road. The difference is then translated into a feedback signal to control a valve to adjust the braking system for preventing the lockup of the wheels and an inefficient braking operation. With this braking system, the brake fluid will be supplied so long as the torque of the wheel brake is no greater than the torque of the ground against the wheel. When the torque of the wheel brake exceeds the torque of the ground against the wheel, the supply of the brake fluid is stopped and the pressure of the brake fluid is lowered until the torque of the wheel brake equals a fixed proportion of the torque of the ground against the wheel.

U.S. Pat. No. 4,665,490 to Masaki presents a design of antiskid control with a surface friction compensation by a prolonged down-pressure operation. In the control process disclosed therein, the speed and acceleration of at least one vehicle wheel are detected to estimate the speed of the vehicle, and then a first and a second threshold values are derived. The wheel speed and the acceleration are compared with the threshold values to estimate the level of the road surface friction and to control the brake pressure.

U.S. Pat. No. 4,739,484 to Fennel presents a method and device for controlling the braking variation in the vehicular brakes with a brake slip control. By the method disclosed therein, the wheel rotational behavior V_{Rad} and, further, a vehicle reference velocity V_{Ref} are determined by sensors and logically combined to produce control signals.

U.S. Pat. No. 4,917,444 to Ishidoet et al., presents an anti-lock brake control method and system for motor vehicles. In that control system, the actual wheel speed of each wheel of the vehicle is detected, and in dependency on the detected wheel speed, a reference vehicle speed is computed. Then, a reference wheel speed lower than the vehicle speed is determined. The control of the braking operation is thus carried out in dependency on the control signals relating to the detected wheel speed and the computed vehicle speed.

U.S. Pat. No. 5,487,598 to Rivard presents a method utilizing a variable duty cycle antilock braking system with an accelerometer. The method disclosed therein uses an operator controlled master cylinder and a second source of pressurized hydraulic fluid for selectively supplying the rebuild pressure. The control process is based on measuring the current vehicle deceleration by repeatedly computing the force causing the deceleration and the wheel speed to search for an optimum wheel speed reference by determining on which side of the peak of a adhesion/slip curve on which the vehicle is operating and, accordingly, to control the braking system as a function of the current wheel speed reference.

U.S. Pat. No. 5,644,490 to Weber presents a method and system for estimating the vehicle speed reference value. By the method disclosed therein, a maximum possible rate of change of the velocity of a vehicle is determined over a predetermined range of the corresponding vehicle speeds. The wheel speed and the estimated reference speed at the wheel are determined along with the rate of change of the wheel speed. The rate of change of the wheel speed is compared with the corresponding maximum possible rate of change of the velocity to limit the estimated reference speed. The improved method of estimating a vehicle speed reference value at a wheel is employed to prevent a false slip detection and a premature ABS activation in a motor vehicle equipped with an anti-locking braking system.

U.S. Pat. No. 5,938,713 to Miyazaki presents a method of building a vehicle antilock braking device via monitoring the frictional force. No device to substantiate the method is carried out in the patent although the working flow diagrams and the sensor system are described. The method of the device design can be described as follows: first, the road surface frictional force is monitored by cyclically increasing the pressure of the brake fluid. The brake fluid pressure is increased when the road surface frictional force increases in response to an increase of the brake fluid pressure. The brake fluid pressure is decreased when the road surface frictional force decreases despite an increase of the brake fluid pressure, and the brake fluid is increased again when the road surface frictional force decreases in response to a decreasing of the brake fluid pressure. The same process can be applied via detecting the road surface friction coefficient. If the process is used via detecting the friction coefficient, then the road surface frictional force and the vertical load are measured with sensors to determine the road surface friction coefficient.

Similarly, all other disclosed methods and control processes of the antilock braking system are based on the understanding of the adhesion/slip curve. Some of the methods try to achieve the goal of preventing the lockup of wheel by measuring the wheel speed and the acceleration to estimate the vehicle velocity and, then, to determine the control signal with an electronic control unit to form a closed-loop control of the braking system. Some other methods try to detect the wheel speed and the vehicle acceleration to compute the vehicle velocity and, then, to determine the control signal with an electronic control unit to form a closed-loop control of the braking system. Still some other methods try to measure the horizontal friction force and then directly generate the control signal with an electronic control unit to form a closed-loop control of the braking system. Yet still other methods try to measure both the horizontal and the vertical forces to determine the frictional coefficient between the tire and the road surface and then generate the control signal to form a closed-loop control of the braking system.

There are several serious problems associating with the antilock braking methods and systems of the prior inventions. The following discussion demonstrates such possible problems.

It is well known in the art that the road is not uniformly smooth. When a vehicle runs on a road, the vibration of wheels of vehicle always exists, especially on a rough road. When a vehicle runs on a rough road, if the wheel is vibrating up to leave the road surface and if an ABS is applied, the vertical contact force between the tire and road surface will become relatively smaller and smaller, and so is the braking force. When the wheel is vibrating down to push the road surface, the vertical contact force between the tire and the road surface will become relatively larger and larger, and so is the braking force.

Therefore, if employing a wheel slip control method to design the ABS, the following problem is unavoidable: Suppose, in braking, when the wheel is down to the ground, the braking torque is applied, and the ABS is working well both for preventing a wheel lockup and for providing an effective braking effort. Because of the vibration caused by the roughness of the road, the wheel may vibrate up. At the beginning, the braking torque will stay the same, but the braking force will become much smaller with the intention of the wheel leaving the rough road. It is clear that the braking torque will rapidly cause a large wheel deceleration, and the slip will rapidly increase. At the same time, the sensor system will immediately detect the change of the wheel slip and command the actuator to release the braking torque to decrease the slip. When the braking torque is released, the wheel may vibrate down to the road, and, thus, the braking force will become larger; but the releasing of the torque results in no sufficient braking effort acting on the vehicle.

The same problem will also occur in operating a vehicle with an ABS adopting the control method of detecting the braking force to generate the control feedback signal. In this case, when the braking torque is increased, the wheel is up because of the vibration, the sensor will detect that the braking force is becoming smaller. The control system may take that situation as one in which, with the increase of the braking torque, the braking force becomes smaller. As a result, the controller may mistakenly determine that it has reached the peak point of the adhesion/slip curve. Accordingly, the controller will command the actuator to reduce the braking torque. However, in the process of reducing the braking torque, the wheel may be down to the road, and, then, the sensor system will detect the increase of braking force. So, the control system will continue to reduce the braking torque since it mistakes the situation as one in which, with the decrease of the braking torque, the braking force is becoming larger. The results are that the braking system may loose control or make an insufficient braking effort.

The same problem will occur with an ABS adopting the control method of detecting the frictional coefficient to generate feedback control signal. In an ABS design with this method, the vertical force and longitudinal force are detected for the purpose of determining the frictional coefficient. When the wheel is up, the vertical force becomes smaller, and an increasing braking torque will rapidly generate a large wheel deceleration and, thus, rapidly increase wheel slippage. When the wheel vibrates down, the braking force will decrease because of the increase of the wheel slip, generating false information that the frictional coefficient is decreasing although, in fact, the frictional coefficient between the tire and road surface stays the same. Such false information will render the braking system to loose control or to make an insufficient braking effort.

Another serious potential risk of increasing the braking torque when the wheel is locked in the braking process always associates with an antilock braking system adopting the control method on the basis of detecting the braking force or detecting the frictional coefficient to generate a feedback control signal. It is noted that, if the wheel is looked, with a decrease of the vehicle speed, the frictional coefficient or the braking force in a longitudinal braking process will increase according to the linear experimental friction coefficient equation

μₛ=μ₀(1−Aₛ×Vₛ)

where μ₀ and μₛ are the nominal and slipping friction coefficient, Aₛ is the speed reduction factor, and Vₛ is the wheel slipping velocity.

Using the method of detecting the braking force or detecting the frictional coefficient, an ABS will monitor the braking force or the frictional coefficient change with the pressure change arising out of a controlling of the brake pressure. If the wheel is locked, the vehicle speed will still be reduced because the braking force is still acting on the wheel. In this situation, if the braking torque is increased, the wheel will stay in the lockup state and the braking force or the frictional coefficient will increase, which may give false information to the controller to continue the process of increasing the braking torque.

It is therefore an object of the present invention to design a ABS control system minimizes vehicle skid.

### SUMMARY OF THE INVENTION

This application discloses various methods of braking control and ABS systems based on acceleration comparison methods. The methods and ABS systems can have various embodiments. The preferred embodiments are acceleration sequence comparison method, acceleration difference comparison method, and acceleration sequence and difference comparison method. Various ABS systems can be constructed on the basis of the methods disclosed in this application.

As a specifically preferred embodiment, the acceleration sequence comparison method contain the following steps:

a) measuring the wheel center acceleration projected on the wheel radius plane in the X direction (Acx) in response to a cyclically controlling of a braking torque wherein differences between the values of a first measured signal of the wheel center acceleration (SA1_{cx}) and a second measured signal (SA2_{cx}) of the wheel center acceleration are determined in sequence for generation of different feedback signals for controlling the braking torque, wherein the cyclical controlling comprises:

i) increasing the corresponding brake fluid pressure when SA1_{cx}≦SA2_{cx} in sequence until SA1_{cx}>SA2_{cx}; or

ii) decreasing the corresponding brake fluid pressure when SA1_{cx}>SA2_{cx} in sequence until SA1_{cx}≦SA2_{cx}; and

b) measuring a wheel angular velocity in a predefined relationship to the wheel radius plane to identify the wheel motion and to generate an angular velocity feedback control signal to control the braking torque by decreasing the corresponding brake fluid pressure when the wheel is locked, wherein the brake fluid can be a liquid or a gas.

An antilock braking system for a wheeled vehicle can be built on the basis of the acceleration sequence method, which include:

a) means for measuring the wheel center acceleration projected on the wheel radius plane in the X direction (A_{cx}) in response to a cyclically controlling of a braking torque wherein differences between the values of a first measured signal of the wheel center acceleration (SA1_{cx}) and a second measured signal (SA2_{cx}) of the wheel center acceleration are determined in sequence for generation of different feedback signals for controlling the braking torque, wherein the cyclical controlling is carried out using:

i) means for increasing the corresponding brake fluid pressure when SA1_{cx}≦SA2_{cx} in sequence until SA1_{cx}>SA2_{cx}; or

ii) means for decreasing the corresponding brake fluid pressure when SA1_{cx}>SA2_{cx} in sequence until SA1_{cx}≦SA2_{cx};

wherein the differences between SA1_{cx} and SA2_{cx} are determined by means for comparing SA1_{cx} and SA2_{cx}; and

b) means for measuring a wheel angular velocity in a predefined relationship to the wheel radius plane to identify the wheel motion and to generate an angular velocity feedback control signal to control the braking torque, wherein the braking torque is controlled using means for decreasing the corresponding brake fluid pressure when the wheel is locked, wherein the brake fluid is either a liquid or a gas.

As another representative embodiment, the acceleration difference comparison can include the following steps:

a) measuring a wheel angular acceleration (A_{w}) in a predefined position to the wheel radius plane and a wheel center acceleration projected on the wheel radius plane in the X direction (A_{cx}) in response to a cyclically controlling of a braking torque wherein differences between the values of a measured signal of A_{w} (SA_{w}) times the wheel radius (R) (R×SA_{w}) of the measured wheel and of a measured signal of the A_{cx} (SA_{cx}) are determined for generation of different feedback signals for controlling the braking torque, wherein the cyclical controlling comprises:

i) increasing the corresponding brake fluid pressure when R×SA_{w}≦SA_{cx} until R×SA_{w}>SA_{cx}; or

ii) decreasing the corresponding brake fluid pressure when R×SA_{w}>SA_{cx} until R×SA_{w}<SA_{cx},

wherein the brake fluid is either a liquid or a gas.

ABS systems can be built upon the acceleration difference comparison method. A preferred ABS system can include:

a) means for measuring a wheel angular acceleration (A_{w}) in a predefined position to the wheel radius plane and a wheel center acceleration projected on the wheel radius plane in the X direction (A_{cx}) in response to a cyclically controlling of a braking torque wherein differences between the values of a measured signal of A_{w} (SA_{w}) times the wheel radius (R) (R×SA_{w}) of the measured wheel and of a measured signal of the A_{cx} (SA_{cx}) are determined for generation of different feedback signals for controlling the braking torque, wherein the cyclical controlling is carried out by using:

i) means for increasing the corresponding brake fluid pressure when R×SA_{w}≦SA_{cx} until R×SA_{w}>SA_{cx}; or

ii) means for decreasing the corresponding brake fluid pressure when R×SA_{w}>SA_{cx} until R×SA_{w}≦SA_{cx},

wherein the brake fluid is either a liquid or a gas.

One of the most preferred method disclosed in this application is acceleration sequence and difference comparison, which is a combination of the acceleration sequence and acceleration difference comparison methods. Various ABS systems can be constructed on the acceleration sequence and difference comparison methods. One of the representative embodiment of such ABS systems can include:

a) means for measuring the wheel center acceleration projected on the wheel radius plane in the X direction (A_{cx}) in response to a cyclically controlling of a braking torque wherein differences between the values of a first measured signal of the wheel center acceleration (SA1_{cx}) and a second measured signal (SA2_{cx}) of the wheel center acceleration are determined in sequence for generation of different feedback signals for controlling the braking torque, wherein the cyclical controlling is carried out using:

j) means for increasing the corresponding brake fluid pressure when SA1_{cx}≦SA2_{cx} in sequence until SA1_{cx}>SA2_{cx}; or

iii) means for decreasing the corresponding brake fluid pressure when SA1_{cx}>SA2_{cx} in sequence until SA1_{cx}≦SA2_{cx};

wherein the differences between SA1_{cx} and SA2_{cx} are determined by means for comparing SA1_{cx} and SA2_{cx}; and

b) means for measuring a wheel angular velocity in a predefined relationship to the wheel radius plane to identify the wheel motion and to generate an angular velocity feedback control signal to control the braking torque, wherein the braking torque is controlled using means for decreasing the corresponding brake fluid pressure when the wheel is locked, wherein the brake fluid is either a liquid or a gas.

c) means for measuring a wheel angular acceleration (A_{w}) in a predefined position to the wheel radius plane in response to a cyclically controlling of a braking torque wherein differences between the values of a measured signal of A_{w} (SA_{w}) times the wheel radius (R) (R×SA_{w}) of the measured wheel and of a measured signal of the A_{cx} (SA_{cx}) are determined for generation of different feedback signals for controlling the braking torque, wherein the cyclical controlling is carried out by using:

i) means for increasing the corresponding brake fluid pressure when R×SA_{w}≦SA_{cx} until R×SA_{w}>SA_{cx}; or

ii) means for decreasing the corresponding brake fluid pressure when R×SA_{w}>SA_{cx} until R×SA_{w}≦SA_{cx}, wherein the SA_{cx} can be SA1_{cx} or SA2_{cx} and wherein the brake fluid is either a liquid or a gas.

### BRIEF DESCRIPTION OF THE DRAWINGS

FIG. 1 illustrates a wheel of vehicle in the braking process.

FIG. 2 is a control flow chart of an antilock braking system employing the acceleration difference comparison method.

FIG. 3 is a control flow chart of an antilock braking system employing the acceleration sequence comparison method.

FIG. 4 is a control flow chart of an antilock braking system employing the acceleration difference and sequence comparison method.

FIG. 5 illustrates an exemplary ABS which is built on the basis of the acceleration difference comparison method.

FIG. 6 illustrates one embodiment of this invention which is built on the basis of the acceleration sequence comparison method.

FIG. 7 illustrates one embodiment of this current invention which is built on the basis of the acceleration difference and sequence comparison methods.

### DETAILED DESCRIPTION OF THE INVENTION

I. Definition

The term “antilock braking system” as used herein means a braking system used in wheeled vehicle that has the function of preventing the wheel of the vehicle from locked up during the braking process.

The term “wheel center acceleration” as used herein means the acceleration at the center of the wheel in the wheel radius plane.

The term “wheel radius plane” refers to the plane defined by the radius of the wheel around the axel 360° at the center of the wheel.

The term “wheel angular velocity” refers to the rotational velocity of the wheel around the axle.

The term “braking torque” as used herein means the torque generated by the braking system acting on the wheel to stop the wheeled vehicle.

The term “feedback” refers to the return to a point of origin of evaluation or corrective information.

The term “feedback control signal” as used herein refers to the return of electric data collected from output which is used to improve the performance of a system or process.

The term “amplified signal” as used herein refers to the electric signal that is amplified from the relatively weak origin of electric signal.

II. ABS System

A. Wheel Transient Theory

It is known that one of the pure rolling conditions of a wheel is

R×A_{w}=A_{cx},

where R is the radius of the wheel. Since R can be considered a constant, by measuring A_{w} and A_{cx}, one can determine if the applied braking torque could cause an instantaneous increment of slip for the purpose of identifying the wheel and the vehicle motion behavior. The currently adopted adhesion/slip curve theory (μ-slip curve) indicates that, when the wheel slip approaches zero, the friction coefficient approaches zero accordingly. μ-Slip curves have been used to describe the effect of the wheel slippage to the friction coefficient when rolling and sliding exist simultaneously. Therefore, they play a crucial role in the design of antilock brake or traction control systems.

As shown by the transient friction coefficient theory developed by Gong, “Transient Process Theory and Antilock Braking System,” Ph.D Dissertation, Tenn. Tech. University (1999) (“Gong”)

μ=λμₛ+(1−λ)μᵣ,

which is fully incorporated into this application by reference, the wheel slippage λ, the pure rolling coefficient μᵣ, and the pure slipping coefficient μₛ play major roles in the wheel transient friction. When λ=0 in a braking process, the braking friction can achieve its maximum value. The result corresponding to the transient friction theory demonstrates that by controlling the braking torque to a margin value in a braking process, a braking system can achieve both the best steering control capability and the maximum braking effort.

In reference to the recent research on the wheel transient theory, it is demonstrated that, when the braking torque acting on the wheel achieves the margin braking torque (Tₘ) and when the wheel slip equals zero, the braking-force acting on the wheel between the tire and the road surface achieves its maximum. Tₘ means that, at this point, any further increment of the braking torque of braking torque change (ΔT) will cause an instantaneous increment of the wheel slip.

This method is different from the currently adopted methods used in ABS designs on the basis of the adhesion/slip curves. The currently adopted adhesion/slip curve theory indicates that, when the wheel slip approaches zero, the friction coefficient approaches zero accordingly. The method and ABS system disclosed in this application, as described below, solve the troubling problem.

B. Acceleration Comparison Methods

In the broadest scope, the method and system as disclosed herein present an ABS control method and system by means of acceleration comparison. This ABS method can take various forms of embodiment. Described bellow are nonlimiting preferred embodiments.

Acceleration Difference Comparison

In one representative embodiment, the acceleration comparison is acceleration sequence comparison. The method of brake control for a wheeled vehicle includes a step of measuring the wheel center acceleration projected on the wheel radius plane in the X direction in response to a cyclically controlling of the increment or decrement or both the increment and decrement of a braking torque to determine the differences between the values of a first measured signal and a second measured signal of the wheel center acceleration in sequence to generate different feedback signals for controlling the braking torque either by increasing the corresponding brake fluid pressure when the value of the first measured signal of the wheel center acceleration is less or equal to the value of the second measured signal of the wheel center acceleration in sequence until the value of the first measured signal of the wheel center acceleration is larger than the value of the second measured signal of the wheel center acceleration or by decreasing the corresponding brake fluid pressure when the value of the first measured signal of the wheel center acceleration is larger than the value of the second measured signal of the wheel center acceleration in sequence until the value of the first measured signal of the wheel center acceleration is less or equal to the value of the second measured signal of the wheel center acceleration. The method disclosed herein can include a step of measuring a wheel angular velocity in a predefined relationship to the wheel radius plane to identify the wheel motion and to generate an angular velocity feedback control signal to control the braking torque by decreasing the corresponding brake fluid pressure when the wheel is locked. The predefined relationship can be any angular relationship, ranging from 0° to 360°. One of ordinary skill in the art would be able to determine which angle to use. For example, one of the preferred angle is a 90° angle.

The method disclosed herein can further include a step of amplifying the first measured signal and the second measured signal of the wheel center acceleration in sequence. The differences of the values of the amplified first measured signal and the amplified second measured signal are compared, and the feedback control signals are generated on the basis of the differences to control the braking torque by increasing or decreasing the brake fluid pressure. In one embodiment, the method disclosed herein further include a step of amplifying a measured angular velocity signal of the wheel angular velocity acceleration; the amplified measured signal is used to make a determination of whether the wheel is in a locked state or unlocked state; and feedback control signals are generated on the basis of the determination to control the braking torque. In another embodiment, the method disclosed herein can further include a step of measuring the wheel center acceleration. In a preferred embodiment, the method disclosed herein further include measuring the angular velocity around the axle of wheel.

A proper braking control in response to the feed back control signals can be achieved by any methods within the knowledge of the art, for example, adjusting the brake fluid pressure. In one embodiment, the brake fluid pressure can be adjusted by using an actuator. In another embodiment, a fluid pressure modulator can be used. In a specifically preferred embodiment, the fluid pressure modulator is controlled by the actuator to generate the corresponding braking torque.

On the basis of the methods disclosed herein, an antilock braking system (“ABS”) for a wheeled vehicle can be constructed accordingly. Generally, the ABS includes means for measuring the wheel center acceleration projected on the wheel radius plane in the X direction in response to cyclically controlling the increment or decrement or both the increment and decrement of a braking torque to determine the differences between the values of a first measured signal and a second measured signal of the wheel center acceleration in sequence to generate different feedback signals for controlling the braking torque either by increasing the corresponding brake fluid pressure when the value of the first measured signal of the wheel center acceleration is less or equal to the value of the second measured signal of the wheel center acceleration in sequence until the value of the first measured signal of the wheel center acceleration is larger than the value of the second measured signal of the wheel center acceleration or by decreasing the corresponding brake fluid pressure when the value of the first measured signal of the wheel center acceleration is larger than the value of the second measured signal of the wheel center acceleration in sequence until the value of the first measured signal of the wheel center acceleration is less or equal to the value of the second measured signal of the wheel center acceleration. The ABS can further includes means for measuring a wheel angular velocity in a predefined relationship to the wheel radius plane to identify the wheel motion and to generate a angular velocity feedback control signal to control the braking torque by decreasing the corresponding brake fluid pressure when the wheel is locked. The ABS can further comprise means for amplifying the first measured signal and the second measured signal of the wheel center acceleration in sequence. The predefined relationship can be any angular relationship, ranging from 0° to 360°. One of ordinary skill in the art would be able to determine which angle to use. For example, one of the preferred angle is a 90° angle. The differences of the values of the amplified first measured signal and the amplified second measured signal are compared to generate feedback control signals on the basis of the differences to control the braking torque by increasing or decreasing the brake fluid pressure. The ABS can further include means for amplifying the measured angular velocity signal of the wheel angular velocity acceleration. The amplified measured signal is used to make a determination of whether the wheel is in a locked state or unlocked state to generate feedback control signals on the basis of the determination to control the braking torque. The ABS disclosed herein can further include means for measuring the wheel center acceleration on the axel center line of a wheel and/or means for measuring the wheel angular velocity around the axel center line of a wheel.

The means for measuring the first measured signal and the second measured signal of the wheel center acceleration, and the means for amplifying the same, and the means for measuring the wheel angular velocity and the means for amplifying the same are within the knowledge of the art. Exemplary means for measuring the first and/or the second signal of the wheel center acceleration in time sequence can be carried out by use of acceleration sensors. Exemplary means for measuring the wheel angular velocity can be carried out by use of angular velocity sensors. Exemplary means for amplifying the first measured signal and the second measured signal of the wheel center acceleration can be carried out by use of amplifiers. Exemplary means for amplifying the measured angular velocity signal can be carried out by use of amplifiers.

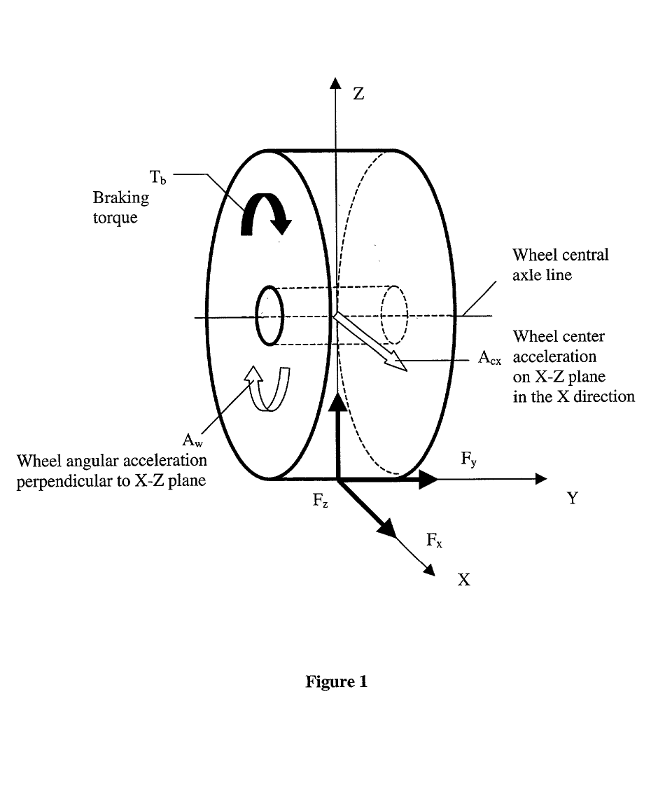

Exemplary embodiments of the method and system disclosed herein are best understood in reference of FIGS. 1-3. FIG. 1 shows a wheel of a vehicle in the braking process. A_{w} is the wheel angular acceleration in a predefined relationship to the wheel radius plane (X-Z plane), and A_{cx} is the projection of the wheel center acceleration on the wheel radius plane in the X direction. The predefined relationship can be any angular relationship, ranging from 0° to 360°. One of ordinary skill in the art would be able to determine which angle to use. For example, one of the preferred angle is a 90° angle.

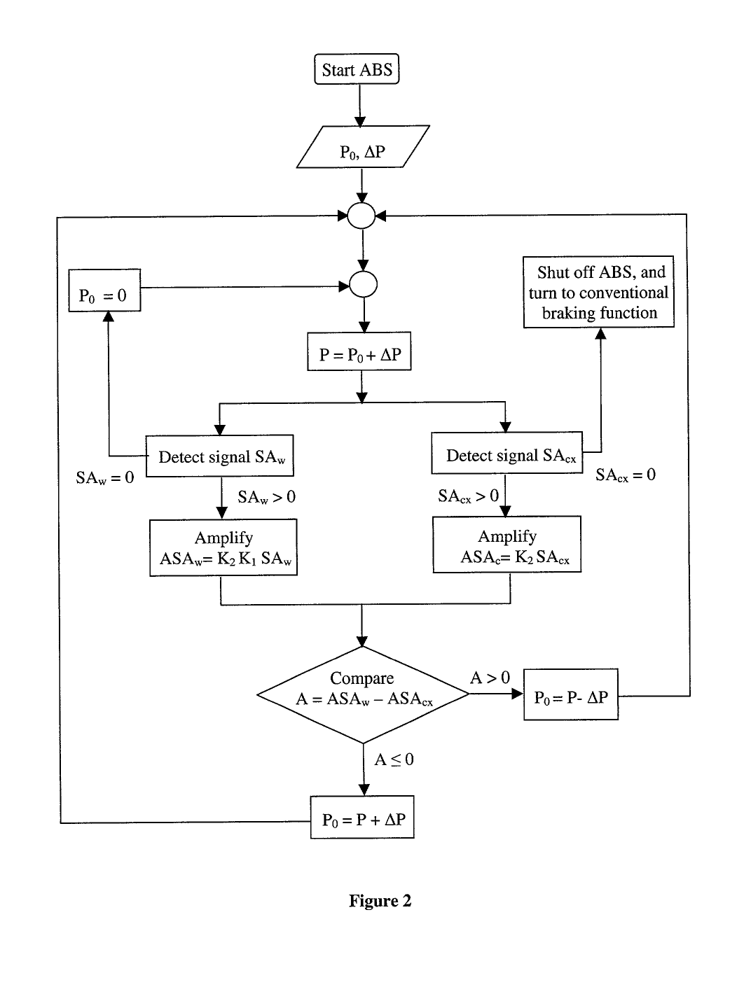

In reference to FIG. 2, A_{w} and A_{cx} are measured along with the corresponding instantaneous signals SA_{w} and SA_{cx}. Both of the detected instantaneous output signals are designed in the same unit level. The detected signals are further amplified, yielding the properties of the vehicle and the corresponding braking system as per equations

ASA_{w}=K₂×K₁×SA_{w},

ASA_{cx}=K₂×SA_{cx}.

Where ASAW is the amplified signal of A_{w}, ASA_{cx} is the amplified signal of A_{cx}, and K₁ is the corresponding compensation corresponding to the property of the wheel radius R. R is considered a constant.

Subsequently, the two amplified instantaneous signals are compared; the difference between the two signals is employed to direct the actuator to adjust the braking torque with the corresponding change of brake fluid pressure. Such a process forms a corresponding closed-loop control of an antilock braking system.

If A=ASA_{w}−ASA_{cx}>0, which means that the braking torque is too large, absent a counteracting mechanism, the braking torque will increase the wheel slip or, more seriously, may lock the wheel. In this case, the braking torque is reduced by directing the actuator to reduce the brake fluid pressure.

If A=ASA_{w}−ASA_{cx}<0, the braking torque will not generate a wheel slip or lock the wheel, but, absent a counteracting mechanism, the braking torque is also not large enough to generate the maximum braking force. To achieve the maximum braking effort, a larger braking torque is needed. Accordingly, the controller commands the actuator to increase the brake fluid pressure, that is, to increase the braking torque.

It is documented that, as aforediscussed, if the initial braking torque is too large, it may instantly lock the wheel. It is also shown that an accumulation of the increment of the wheel slip caused by cyclically increasing and decreasing the braking torque may gradually lock the wheel. When this wheel lockup problem occurs, then, the detected signal SA_{w}=0. To avoid the lockup problem, once signal SA_{w}=0, an ABS design disclosed herein allows the braking pressure to be released, enabling the locked wheel to regain its angular velocity and to reduce the slippage rapidly.

With a continuous adjustment of the braking torque, the braking system will always achieve the margin braking torque with the minimum wheel slip, which means acquiring the maximum braking effort as well as the maximum steering capability.

Other problems associating with the ABS designs adopting the control methods as presented in prior inventions can be solved in this invention. As an example, the following analysis shows the results when an antilock braking system adopting this invention is applied when a vehicle runs on a rough road with vibration.

When a wheel vibrates up, the wheel center deceleration in the wheel plane will become smaller along with the decrease of the braking force, and the wheel angular deceleration instantly increases as per equation

ASA_{w}>ASA_{cx}, that is, R×A_{w}>A_{cx}.

Then, the sensor system immediately detects the change. Subsequently, the control system reduces the brake fluid pressure accordingly. The braking torque is thus instantly reduced to avoid the possible lockup of wheel.

When the wheel is down, as the braking force increases, the wheel center deceleration in the wheel plane becomes larger, and the wheel angular deceleration decreases as per equation

ASA_{w}<ASA_{cx}, that is, R×A_{w}<A_{cx}.

Then, the sensor system detects the instant change. Subsequently, the control system increases the brake fluid pressure accordingly. An increasing of the braking torque ensures a sufficient braking effort.

The problem of increasing the braking torque when the wheel is locked, which may exist in an antilock system adopting the methods of using braking force and frictional coefficient as the control variables, does not exist in the system disclosed herein. The system disclosed herein enables the detected signals to clearly identify this situation to avoid the lockup problem. If a wheel is locked in braking, then

A_{w}=0, that is, ASA_{w}=0, and

A_{cx}>0, that is, ASA_{cx}>0.

As a result, if ASA_{w}=0 and ASA_{cx}>0, the brake fluid pressure is released.

FIG. 2 also demonstrates that, once A_{cx}=0, that is, the vehicle is stopped, the function of the antilock braking system is turned off. The system thus becomes a conventional braking system, bringing the vehicle to a halt.

Acceleration Sequence Comparison

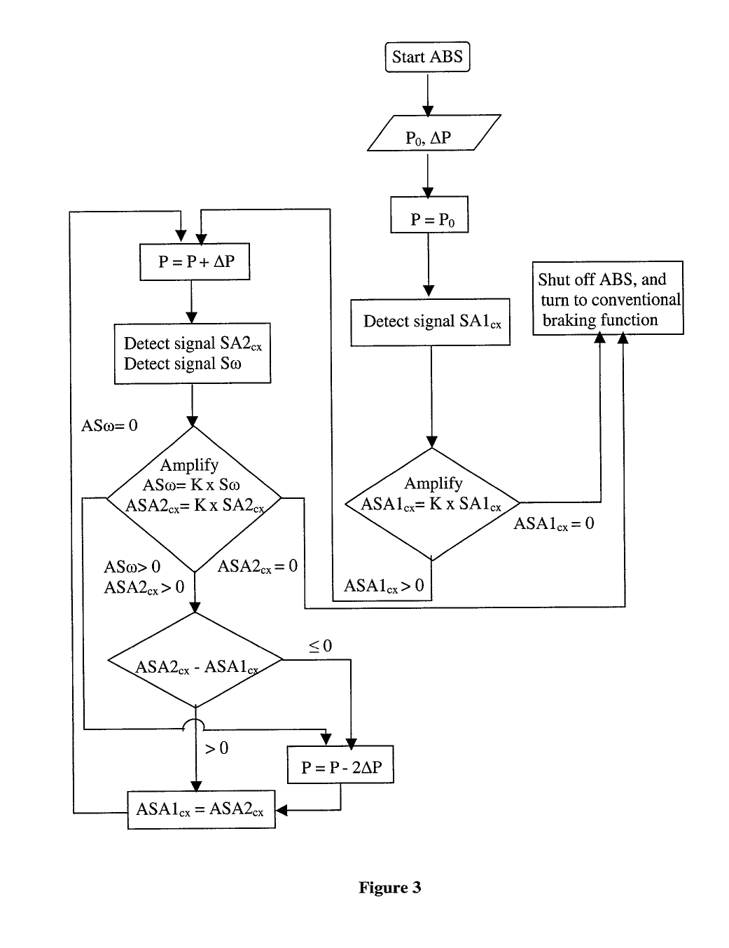

Another representative acceleration comparison is acceleration difference comparison. FIG. 3 is a control flow chart of an antilock braking system employing the acceleration sequence comparison method.

In reference to FIG. 3, A_{cx} is first measured in sequence along with corresponding instantaneous signals of SA1_{cx} and SA2_{cx}. The detected signals are further amplified according to equations

ASA1_{cx}=K×SA1_{cx}, and

ASA2_{cx}=K×SA2_{cx}.

Then, the two amplified instantaneous signals, ASA2_{cx} and ASA1_{cx}, are compared in sequence with each other; the difference between the two signals is employed to directly command the actuator to adjust the braking torque. Consequently, such a process forms a corresponding closed-loop control of an antilock braking system.

FIG. 3 shows that, when ASA1_{cx} or ASA2_{cx}=0, meaning the vehicle is stopped, the system is turned into a conventional braking system.

If ASA2_{cx}−ASA1_{cx}>0, then, the wheel center acceleration will increase with the increment of the braking torque, meaning that a continuous increasing of the braking torque may give rise to the maximum braking effort meanwhile generating the maximum steering capability. Accordingly, in this case, with the control flow the braking torque is increased through the actuator by increasing the brake fluid pressure.

If ASA2_{cx}−ASA1_{cx}<0, then, the wheel center acceleration will not increase along with the increment of the braking torque, which means that the maximum point of the braking friction force has just been reached. Absent a counteracting mechanism, a further increment of the braking torque will cause a reduction of the braking force and an increment of the wheel slip. In this invention, the braking torque is decreased through an actuator by decreasing the brake fluid pressure. Thus, by a continuous adjustment of the braking torque, the braking system will always achieve the margin braking torque with a minimum wheel slip, acquiring the maximum braking effort and the maximum steering capability.

To avoid the serious potential risk of increasing the braking torque when the wheel is locked in the braking process, FIG. 3 illustrates a mechanism disclosed in this invention, which demonstrates that, when the measured signal of Asω is zero, which means the monitored wheel is locked, the braking torque is accordingly reduced.

FIG. 3 also shows that once A_{cx}=0, that is, the vehicle is stopped, the function of the antilock braking system is turned off. The system thus becomes a conventional braking system, bringing the vehicle to a halt.

Acceleration Difference and Sequence Comparison

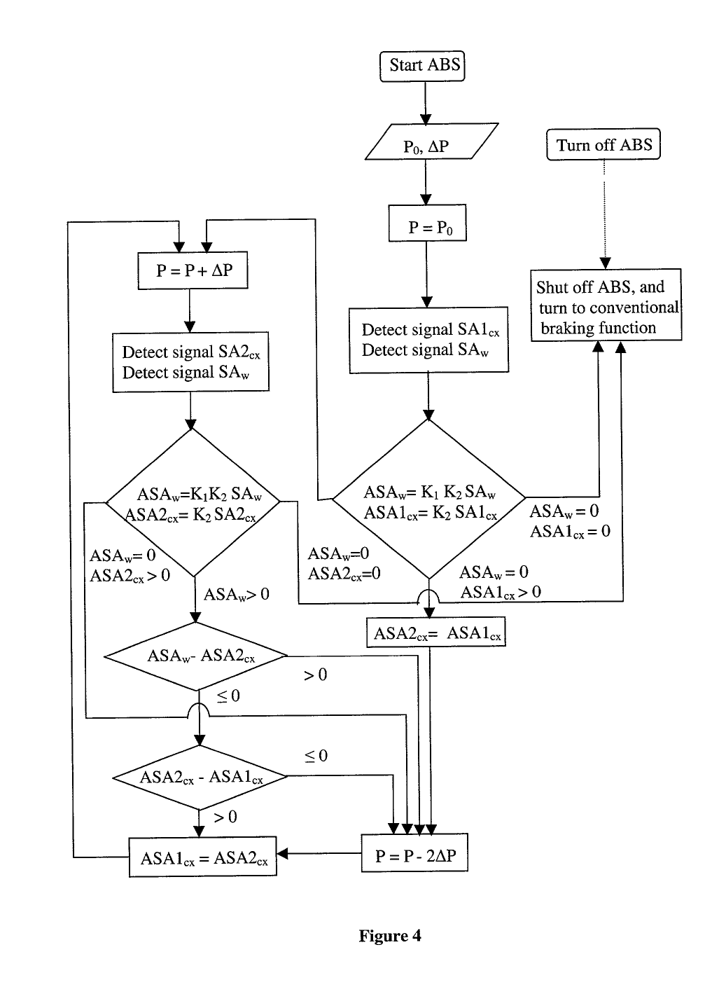

A further representative acceleration comparison is acceleration difference and sequence comparison. FIG. 4 is a control flow chart of an antilock braking system employing the acceleration difference and sequence comparison method.

In reference to FIG. 4, A_{w} and A_{cx} are measured with their corresponding instantaneous signals SA_{w} and SA_{cx}. Both of the detected instantaneous output signals are designed in the same unit level. The detected signals are further amplified, yielding the properties of the vehicle and corresponding braking system as per equations

ASA_{w}=K₂×K₁×SA_{w},

ASA_{cx}=K₂×SA_{cx}.

where ASA_{w} is the amplified signal of A_{w}, ASA_{cx} is the amplified signal of A_{cx}, and K₁ is the compensation factor corresponding to the property of the wheel radius R. R is considered a constant. The A_{w} is in a predefined relationship to the wheel radius plane (X-Z plane as shown in FIG. 1). The predefined relationship can be any angular relationship, ranging from 0° to 360°. One of ordinary skill in the art would be able to determine which angle to use. For example, one of the preferred angle is a 90° angle.

Subsequently, the two amplified instantaneous signals are compared, and the difference between the two signals is employed to directly control the actuator to adjust the braking torque with the corresponding change of brake fluid pressure. Such a process forms a corresponding closed-loop control of an antilock braking system.

If A=ASA_{w}−ASA_{cx}>0, which means that the braking torque is too large, absent a counteracting mechanism, the excessive braking torque will increase the wheel slip or, more seriously, may lock the wheel. In this invention, the braking torque is reduced through an actuator by reducing the brake fluid pressure.

If A=ASA_{w}−ASA_{cx}≦0, the braking torque will not generate wheel slip, nor lock the wheel. However, the braking torque is not sufficient to generate a maximum braking force, either. To achieve the maximum braking effort, a larger braking torque is needed. Therefore, in this invention, the controller will command the actuator to increase the brake fluid pressure, that is, to increase the braking torque.

It is well known in the art that, if the initial braking torque is too large, the braking torque may instantly lock the wheel. Likewise, an accumulation of the increment of wheel slip caused by the cyclic increasing and decreasing of the braking torque may also gradually lock the wheel. Shall this problem occurs, the detected signal SA_{w}=0. To avoid this lockup problem, in this invention, the braking pressure will be released once signal SA_{w}=0, enabling the locked wheel to regain its angular velocity and to reduce the slippage rapidly. As the result, by a continuous adjustment of braking torque, the braking system will always achieve the margin braking torque with a minimum wheel slip, acquiring both the maximum braking effort and the maximum steering capability.

The problems associating with the ABS designs adopting the control methods presented by the prior inventions can be solved with this method. The following analysis, as an example, demonstrates the results when such a antilock braking system adopting this invention is applied when a vehicle having such an ABS runs on a rough road with vibration.

First, when a wheel vibrates up, the wheel center deceleration in the wheel plane will become smaller as the braking force decreases. Meanwhile, the wheel angular deceleration will instantly increase as per equation

ASA_{w}>ASA_{cx}, that is, R×A_{w}>A_{cx}.

Subsequently, the sensor system will immediately detect the change, and the control system will reduce the brake fluid pressure accordingly, that is, the braking torque is instantly reduced to avoid a possible lockup of wheel.

Similarly, when the wheel is down, the wheel center deceleration in the wheel plane will become larger as the braking force increases. Meanwhile, the wheel angular deceleration will decrease as per equation

ASA_{w}<ASA_{cx}, that is, R×A_{w}<A_{cx}.

Subsequently, the sensor system will detect the instant change, and the control system will immediately increase the brake fluid pressure accordingly. The result is that the braking torque generates sufficient braking effort.

The risk of increasing braking torque when the wheel is locked which may exist in an antilock system adopting the methods of using braking force and frictional coefficient as the control variables will not exist in the method presented in this invention. Using this method, the detected signals clearly identifies this situation to avoid the problem. For instance, if the wheel is locked in the braking process, then

A_{w}=0, that is, ASA_{w}=0, and

A_{cx}>0, that is, ASA_{cx}>0.

Once the controller detects that ASA_{w}=0 and ASA_{cx}>0, the brake fluid pressure is released accordingly.

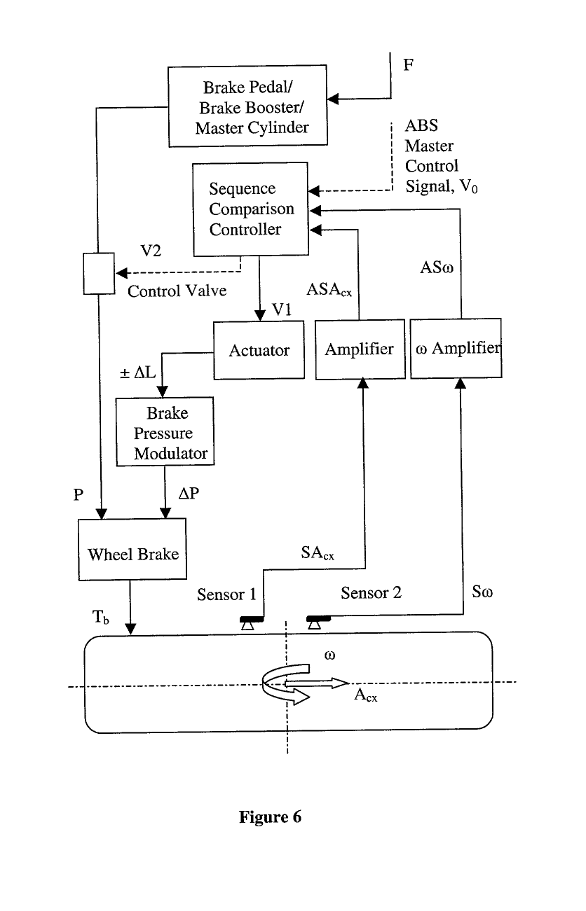

Further, in reference to FIG. 6, A_{cx} is measured in sequence along with the corresponding instantaneous signals of SA1_{cx} and SA2_{cx}. The detected signals are further amplified as per

ASA1_{cx}=K×SA1_{cx}, and

ASA2_{cx}=K×SA2_{cx}.

Subsequently, the two amplified instantaneous signals, ASA2_{cx} and ASA1_{cx}, are compared in sequence with each other, and the difference between the two signals is employed to directly direct the actuator to adjust the braking torque. Such a process forms a corresponding closed-loop control of an antilock braking system. FIG. 4 shows that, if ASA1_{cx} or ASA2_{cx}=0, which means that the vehicle is stopped, the system is turned to a conventional braking system, bringing the vehicle to a halt.

If ASA2_{cx}−ASA1_{cx}>0, meaning that the wheel center acceleration will increase along with the increment of the braking torque, a continuous increasing of the braking torque may achieve a maximum braking effort meanwhile acquiring the maximum steering capability also. Therefore, per the control flow, the braking torque is increased via the actuator to increase the brake fluid pressure.

If ASA2_{cx}−ASA1_{cx}<0, the wheel center acceleration will not increase along with an increment of the braking torque, which means that the maximum point of the braking friction force has just reached. In this situation, absent a counteracting mechanism, a further increment of the braking torque will cause a reduction of the braking force and an increment of wheel slip. Therefore, the braking torque is decreased through the actuator by decreasing the brake fluid pressure. As a result, by a continuous adjustment of the braking torque, the braking system will always acquire the margin braking torque with a minimum wheel slip, which means generating the maximum braking effort with the maximum steering capability.

To avoid the serious potential risk of increasing the braking torque when the wheel is locked in braking process, FIG. 4 shows a mechanism that, if the measured signal of A_{w} is zero and A_{cx} is non-zero, meaning the monitored wheel is locked, the braking torque is reduced.

In another representative embodiment, the control mechanism based on the acceleration sequence method an that based on the acceleration difference method can be integrated to provide a dual brake control system which one of the two mechanisms can be automatically selected if desirable. The selection of one mechanism over the other can be achieved either manually or automatically.

Mechanical Embodiment

The present method and system can have various mechanical embodiments. Those of skill in the art would be able to construct various antilock brake systems embodying the methods as disclosed in this application. Various optical or electronic sensors and brake-torque controlling devices are readily available and accessible to one skilled in the art. For example, strain gauges, potentiometers, spring sensors, magnetoresistive sensors, fiber-optic sensors, Hall sensors, piezoelectric sensors, capacitive silicon sensors, RPM and velocity sensors, inductive sensors, static monitoring, etc.

In one representative embodiment, the wheel center acceleration is monitored by using a wheel center acceleration sensor. The wheel angular acceleration is monitored by using a wheel angular acceleration sensor. The wheel angular velocity can be monitored by using a wheel angular velocity sensor. The signals generated can be received and the values can be compared using various devices or means available in the art. The means for comparing the values of various signals can be a conventional electronic device, for example, a microchip of ECU, microcomputer or a centralized main-frame computer. The means for generating feed back signals can be either electronic signal of voltage or current.

In another representative embodiment, the brake torque can be controlled using one or a plurality of actuator to control one or a plurality of fluid pressure modulator. The actuator and/or the pressure modulator can be based on a gas or gaseous material or a supercritical fluid material.

The selection of one brake control mechanism over the other can be carried out by either a manual switch, a conventional electronic or optical device, such as photoelectric control, a microchip of ECU or a computer. One of skill in the art can determine which device to use.

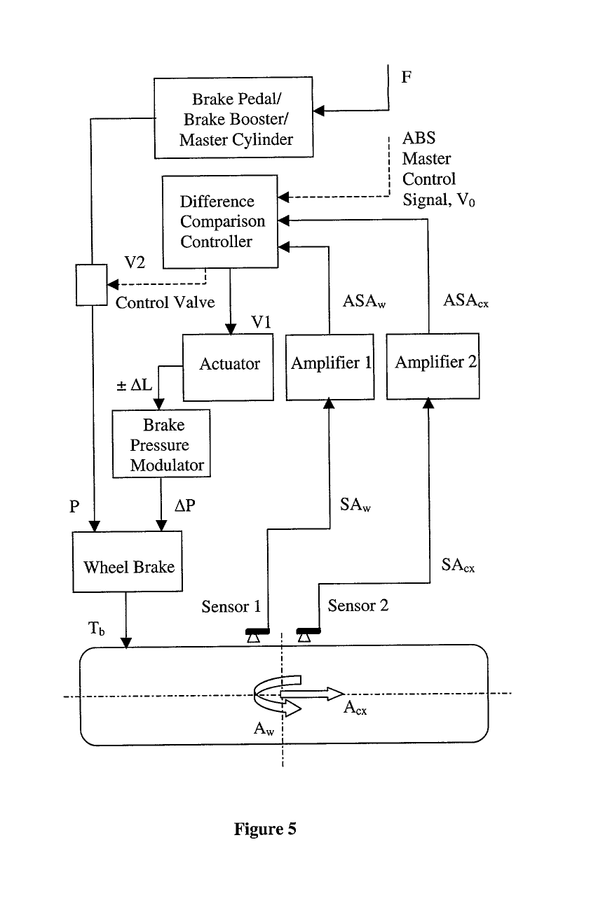

FIGS. 5-7 illustrate a few specifically preferred embodiments of the ABS systems disclosed in this application. FIG. 5 is an illustration of an ABS system built upon the acceleration difference comparison method as applied to a wheeled vehicle. One of the features in implementing the system disclosed herein in an antilock braking system design is to use at least one actuator to direct a fluid pressure modulator to gradually change the brake fluid pressure, that is, to change the braking torque step by step during the braking. The pressure change can be gradually decreasing or gradually increasing, depending on the control signal.

Another feature of the method and system disclosed herein is to mount at least two acceleration sensors fitted to a wheeled vehicle on at least one wheel to detect the wheel angular deceleration and the wheel center deceleration in the wheel plane in correspondence to a gradual changing of the braking torque.

Another feature of the method and system disclosed herein is to amplify the detected signals of the wheel angular deceleration and the wheel center deceleration in the wheel plane, yielding the properties of the vehicle and the braking system.

Still another feature is of the method and system disclosed herein to compare the amplified signals to determine the corresponding feedback control signal. Still another feature of the method and system disclosed herein is to use the feedback control signal to directly control the actuator for generating a corresponding braking torque to prevent the lockup of the wheels and to ensure the maximum braking effort.

FIG. 6 is an illustration of an ABS system built upon the method of acceleration sequence comparison. One of the features in the embodiment of this invention illustrated by FIG. 6 is to use at least one actuator to direct a fluid pressure modulator to gradually change the brake fluid pressure, that is, to change the braking torque step by step during the braking. The said pressure change, depending on the control signal, can be gradually decreasing or gradually increasing.

Still one of the features in this invention embodied by FIG. 6 is to mount at least one acceleration sensor fitted to a wheeled vehicle on at least one wheel to detect the wheel center deceleration projected on the X-Z plane in the X direction corresponding to a gradually changing of the braking torque.

Another feature illustrated by FIG. 6 is to mount at least one angular velocity sensor fitted to a wheeled vehicle on at least one wheel to detect the wheel angular velocity for the purpose of determining the state of wheel lockup.

Also, another feature illustrated by FIG. 6 is to amplify the detected signals of the wheel angular velocity and of the wheel center deceleration. Still another feature illustrated by FIG. 6 is to compare the amplified signals in sequence to determine the corresponding feedback control signal. Also, still another feature illustrated by FIG. 6 is to use the feedback control signal to directly control the actuator to generate a corresponding braking torque to prevent the lockup of wheels and to achieve the maximum braking effort.

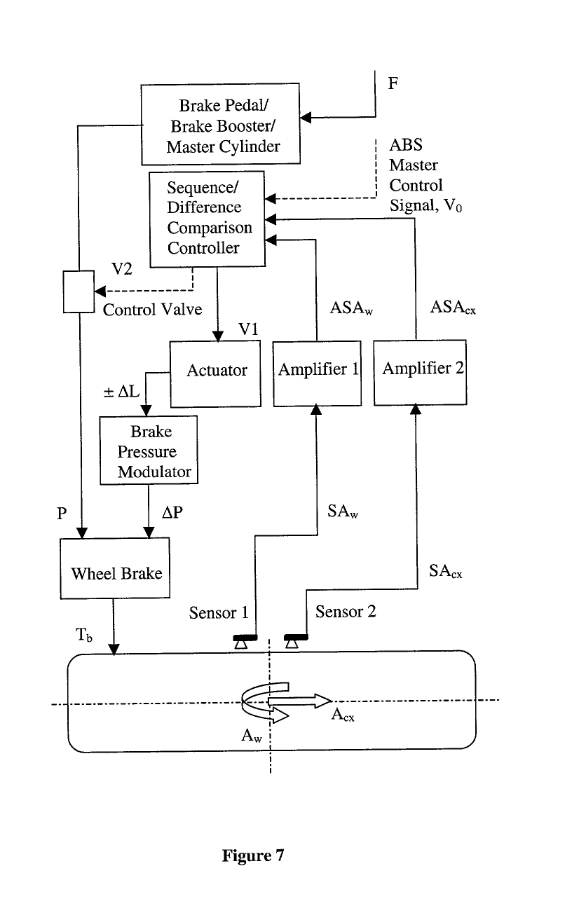

FIG. 7 is an illustration of an ABS system built upon the acceleration difference and sequence comparison method. One of the features of this invention to implement the method in an antilock braking system design is to use at least one actuator to direct a fluid pressure modulator to gradually change the brake fluid pressure, that is, to change the braking torque step by step during the braking. The said pressure change can be gradually decreasing or gradually increasing, depending on the control signal.

Still one of the features of this invention is to mount at least two acceleration sensors fitted to a wheeled vehicle on at least one wheel to detect the wheel angular deceleration and the wheel center deceleration in the wheel plane corresponding to the gradually changing of the braking torque.

Another feature of the invention is to amplify the detected signals of the wheel angular deceleration and the wheel center deceleration in the wheel plane, yielding the properties of the vehicle and the braking system. Another feature of the invention is to determine the difference between the amplified wheel angular deceleration signal and the amplified wheel center deceleration signal to generate a corresponding control signal.

Still another feature of the invention is to determine the difference of the amplified wheel center deceleration signals in sequence to generate a corresponding control signal. Another feature of the invention is to combine the control signals to finally generate a corresponding feedback control signal of the antilock braking system.

Still another feature of the invention is to use the feedback control signal to directly command the actuator to generate a corresponding braking torque to prevent the lockup of wheels and to acquire maximum braking effort.

We claim:

1. A method of brake control for a wheeled vehicle comprising:
a) measuring the wheel center acceleration projected on the wheel radius plane in the X direction (Acx) in response to a cyclically controlling of a braking torque wherein differences between the values of a first measured signal of the wheel center acceleration (SA1_{cx}) and a second measured signal (SA2_{cx}) of the wheel center acceleration are determined in sequence for generation of different feedback signals for controlling the braking torque, wherein the cyclical controlling comprises:
i) increasing the corresponding brake fluid pressure when SA1_{cx}≦SA2_{cx} in sequence until SA1_{cx}>SA2_{cx}; or
ii) decreasing the corresponding brake fluid pressure when SA1_{cx}>SA2_{cx} in sequence until SA1_{cx}≦SA2_{cx}; and
b) measuring a wheel angular velocity in a predefined relationship to the wheel radius plane to identify the wheel motion and to generate an angular velocity feedback control signal to control the braking torque by decreasing the corresponding brake fluid pressure when the wheel is locked, wherein the brake fluid can be a liquid or a gas.

2. The method of claim 1 wherein the SA1_{cx} and SA2_{cx} are amplified.

3. The method of claim 1 wherein the measured signal of the wheel angular velocity is amplified.

4. The method of claim 1 wherein the predefined relationship is a perpendicular relationship.

5. An antilock braking system for a wheeled vehicle comprising:
a) means for measuring the wheel center acceleration projected on the wheel radius plane in the X direction (A_{cx}) in response to a cyclically controlling of a braking torque wherein differences between the values of a first measured signal of the wheel center acceleration (SA1_{cx}) and a second measured signal (SA2_{cx}) of the wheel center acceleration are determined in sequence for generation of different feedback signals for controlling the braking torque, wherein the cyclical controlling is carried out using:
i) means for increasing the corresponding brake fluid pressure when SA1_{cx}≦SA2_{cx} in sequence until SA1_{cx}>SA2_{cx}; or
ii) means for decreasing the corresponding brake fluid pressure when SA1_{cx}>SA2_{cx} in sequence until SA1_{cx}≦SA2_{cx};
wherein the differences between SA1_{cx} and SA2_{cx} are determined by means for comparing SA1_{cx} and SA2_{cx}; and
b) means for measuring a wheel angular velocity in a predefined relationship to the wheel radius plane to identify the wheel motion and to generate an angular velocity feedback control signal to control the braking torque, wherein the braking torgue is controlled using means for decreasing the corresponding brake fluid pressure when the wheel is locked, wherein the brake fluid is either a liquid or a gas.

6. The system of claim 5 further comprising means for comparing the values of SA1_{cx} and SA2_{cx}.

7. The system of claim 6 further comprising:
c) means for amplifying the SA1_{cx} and SA2_{cx} in sequence;
d) means for amplifying the measured angular velocity signal of the wheel angular velocity;

8. The system of any one of claims 5-7 wherein the predefined relationship is a perpendicular relationship.

9. The system of claim 8 further comprising:
e) means for measuring A_{cx}; and
f) means for measuring the wheel angular velocity around the axel center line of a wheel.

10. The system of claim 8 wherein the brake fluid pressure is adjusted by using at least an actuator and at least a fluid pressure modulator; whereby the fluid pressure modulator is controlled by the actuator to generate the corresponding braking torque.

11. The system of claim 10 wherein the means for measuring the A_{cx} comprises at least one acceleration sensor mounted on at least one wheel of the vehicle; and wherein the means for amplifying the first measured signal and the second measured signal of the wheel center acceleration comprises at least an amplifier.

12. The system of claim 11 wherein the means for measuring the wheel angular velocity comprises at least one angular velocity sensor; and wherein the means for amplifying the measured angular velocity signal comprises at least an amplifier.

13. A method of brake control for a wheeled vehicle comprising:
a) measuring a wheel angular acceleration (A_{w}) in a predefined position to the wheel radius plane and a wheel center acceleration projected on the wheel radius plane in the X direction (A_{cx}) in response to a cyclically controlling of a braking torque wherein differences between the values of a measured signal of A_{w} (SA_{w}) times the wheel radius (R) (R×SA_{w}) of the measured wheel and of a measured signal of the A_{cx} (SA_{cx}) are determined for generation of different feedback signals for controlling the braking torque, wherein the cyclical controlling comprises:
i) increasing the corresponding brake fluid pressure when R×SA_{w}≦SA_{cx} until R×SA_{w}>SA_{cx}; or
ii) decreasing the corresponding brake fluid pressure when R×SA_{w}>SA_{cx} until R×SA_{w}<SA_{cx},
wherein the brake fluid is either a liquid or a gas.

14. The method of claim 13 wherein the SA_{w} and SA_{cx} are amplified.

15. The method of claim 13 or claim 14 wherein the predefined relationship is a perpendicular relationship.

16. The method of claim 15 further comprising:
b) measuring the wheel center acceleration on the axel center line of a wheel.

17. An antilock braking system for a wheeled vehicle comprising:
a) means for measuring a wheel angular acceleration (A_{w}) in a predefined position to the wheel radius plane and a wheel center acceleration projected on the wheel radius plane in the X direction (A_{cx}) in response to a cyclically controlling of a braking torque wherein differences between the values of a measured signal of A_{w} (SA_{w}) times the wheel radius (R) (R×SA_{w}) of the measured wheel and of a measured signal of the A_{cx} (SA_{cx}) are determined for generation of different feedback signals for controlling the braking torque, wherein the cyclical controlling is carried out by using:
i) means for increasing the corresponding brake fluid pressure when R×SA_{w}≦SA_{cx} until R×SA_{w}>SA_{cx}; or
ii) means for decreasing the corresponding brake fluid pressure when R×SA_{w}>SA_{cx} until R×SA_{w}≦SA_{cx},
wherein the brake fluid is either a liquid or a gas.

18. The system of claim 17 further comprising means for comparing the values of SA_{w} and SA_{cx}.

19. The system of claim 18 further comprising:
b) means for measuring the A_{w} around the axel center line of a wheel.
c) means for measuring the A_{cx} on the axel center line of a wheel.

20. The system of claim 19 further comprising:
d) means for amplifying the SA_{w} and SA_{cx};

21. The system of one of claims 17-20 wherein the predefined relationship is a perpendicular relationship.

22. The system of claim 21 wherein the brake fluid pressure is adjusted by using at least an actuator and at least a fluid pressure modulator; whereby the fluid pressure modulator is controlled by the actuator to generate the corresponding braking torque.

23. The system of claim 20 wherein the means for measuring the A_{cx} comprises at least one acceleration sensor mounted on at least one wheel of the vehicle; wherein the means for amplifying A_{cx} comprises at least an amplifier; wherein the means for measuring the A_{w} comprises at least one angular acceleration sensor; and wherein the means for amplifying the A_{w} comprises at least an amplifier.

24. The antilock braking system of any one of claims 5-12 further comprising:
c) means for measuring a wheel angular acceleration (A_{w}) in a predefined position to the wheel radius plane in response to a cyclically controlling of a braking torque wherein differences between the values of a measured signal of A_{w} (SA_{w}) times the wheel radius (R) (R×SA_{w}) of the measured wheel and of a measured signal of the A_{cx} (SA_{cx}) are determined for generation of different feedback signals for controlling the braking torque, wherein the cyclical controlling is carried out by using:
i) means for increasing the corresponding brake fluid pressure when R×SA_{w}≦SA_{cx} until R×SA_{w}>SA_{cx}; or
ii) means for decreasing the corresponding brake fluid pressure when R×SA_{w}>SA_{cx} until R×SA_{w}≦SA_{cx},
wherein the SA_{cx} can be SA1_{cx} or SA2_{cx} and wherein the brake fluid is either a liquid or a gas.

25. The system of claim 24 further comprising means for comparing the values of R×SA_{w}≦SA_{cx}.

26. The system of claim 25 further comprising means for measuring the A_{w} around the axel center line of a wheel.

27. The system of claim 26 wherein the means for measuring the A_{w} comprises at least one angular acceleration sensor; and wherein the means for amplifying the SA_{w} comprises at least an amplifier.
